(19) United States
(12) Patent Application Publication
(10) Pub. No.: US 2013/0219267 A1
(43) Pub. Date: Aug. 22, 2013

(54) SYSTEM AND METHOD OF SOCIAL PUBLISHING

(71) Applicants: Nicolas GREMION, Ste. Domingo de Heredia (CR); Dino Angelov, Strumica (MK); Ricardo Toledo, Santa Ana (CR)

(72) Inventors: Nicolas GREMION, Ste. Domingo de Heredia (CR); Dino Angelov, Strumica (MK); Ricardo Toledo, Santa Ana (CR)

(21) Appl. No.: 13/398,218

(22) Filed: Feb. 16, 2012

(51) Int. Cl. G06F 17/24

(52) U.S. Cl. 715/256

(57) ABSTRACT

The invention provides a system and method of collaborative publishing including a computer operated by software with machine-readable instructions to allow a first user to connect with other users, utilize a brainstorming aide for customized writing assistance, collaboratively or independently draft and a book, and review and publish a book.

### BACKGROUND OF THE INVENTION

A. Field of Invention

The present application relates generally to a system and method of social publishing. More specifically, the system includes at least one computer operated by software (that constitutes a non-transitory medium) with machine-readable instructions to allow a user to connect with other users, collaboratively or independently draft and publish a book, utilize a brainstorming aide for customized writing assistance, and review and publish a book. The computer and/or server also contains a library of both user and third-party published books. Furthermore, the computer includes software with instructions encoded thereon to allow a user to interact with published books through forming a social group, commenting on books, forming discussions, and tracking authors or other members. Preferably, the computer is accessed online by a plurality of authors and others interested in collaborating to write books. Preferably, the computer serves one or more websites available to others by subscription.

B. Description of the Prior Art

Successful authoring requires, among other steps, conception of an idea, brainstorming associated with how the idea may be broken down to readers, the actual writing of the work, the continual editing of that writing, publication of a final edited work, and distribution of that final edit to a sufficient quantity of readers such that the author may earn a profit on the work. Often times, authors will encounter difficulty in the process of creating a written work. Such difficulty can occur at any point in that process from conception to distribution.

Specifically, because the writing process is a tedious effort, many would-be authors are discouraged from starting or finishing a work. Also, many would-be authors are uncertain about where to begin the writing process, are faced with “writer's block” along the way, or are unable to produce a finely-edited and complete product. Thus, it can be helpful for the author to consult with another author or associate in order to garner assistance and proceed with the composition of a work.

Furthermore, even if an individual can accomplish writing a book, a writer must still overcome the hurdles of publishing the book and earning a profit. However, with most publications changing over to digital media, books, magazines, and other publications are capable of distribution at very little cost to the publisher. Additionally, because publishing electronically over the Internet is relatively cheap and simple, authors are able to disseminate their works easier. Nevertheless, attracting readers and earning a profit continues to present difficulties.

Some existing systems allow a user to write a work, adding chapters and summaries; connect with other users to co-author a work; publish a work; and sell that work on established electronic databases. Despite the proposed utility of existing systems, these tools suffer from a number of deficiencies. For example, while a user is able to invite co-authors, the co-author is not supplied with the necessary information required to effectively collaborate. Instead, a co-author is merely presented with the option to join the primary author in writing a certain piece, without imperative information such as a focus for the work, an indication of the intended audience, or a desired timeline or length associated with the work.

Additionally, while these tools allow for co-authorship, they do not provide a system whereby a primary author may solicit assistance at any point involved in the publication process from conception to dissemination. Instead, a primary author may simply invite a co-author to provide writing to be incorporated into the publication. Any collaboration during the other phases of authoring must be done over traditional back-and-forth exchanges of information such as emails, telephone or video-conferencing calls, or in-person meetings. Because of the nature of such exchanges, there is a likelihood that information may be miscommunicated, overlooked, or simply missed altogether. Furthermore, the time required to participate in such correspondence is so significant that it can drastically delay the publication or even halt the process altogether.

### SUMMARY OF THE INVENTION

The present invention provides a system and method of collaborative publishing including at least one computer having software thereon to allow a user to connect with other users, collaboratively or independently draft and publish a book, utilize a brainstorming aide for customized writing assistance that all collaborators can work off of, and review and publish a book.

The present invention further provides an electronic library of both user and third-party published books for users to browse, read, and comment on.

In summary, there is provided in a preferred embodiment of the present invention an improved system and method for collaborative publishing including at least one computer having software thereon to provide a book basics module, a brainstorming module, an illustration module, a work desk module, a revision and publication module, a library module, and a community module.

The at least one computer and method presented herein is configured to allow a user to connect with other users, collaboratively or independently draft and publish a book, utilize a brainstorming aide for customized writing assistance, and review and publish a book. The at least one computer also contains an electronic library of both user and third-party published books. Furthermore, the at least one computer has software thereon to allow a user to interact with published books through forming a social group, commenting on books, forming discussions, and tracking authors. Additional features of the invention are described below in more detail.

### BRIEF DESCRIPTIONS OF THE DRAWINGS

The above-described and other advantages and features of the present disclosure will be appreciated and understood by those skilled in the art from the following detailed description and drawings of which:

FIG. 1 is a block diagram of an Internet-based collaborative publication system constructed in accordance with this invention;

FIG. 2 illustrates a typical session generating a published book;

FIG. 3 is an illustrative flowchart for generating a set of initial parameters for the original book, preferably performed by a book basics module;

FIG. 4 is an illustrative flowchart for generating information and actual content using more creative activities for non-fiction works then what was involved in the process of FIG. 3 and, preferably performed by the brainstorming module;

FIG. 5 is an illustrative flowchart for generating information and actual content using more creative activities for fiction works then what was involved in the process of FIG. 3 and, preferably performed by the brainstorming module;

FIG. 6 illustrates the various processes that a reader can access on the at least one computer; and

FIG. 7 illustrates the various ways that the modules of FIG. 2 may be accessed by different users.

### DETAILED DESCRIPTION OF THE INVENTION

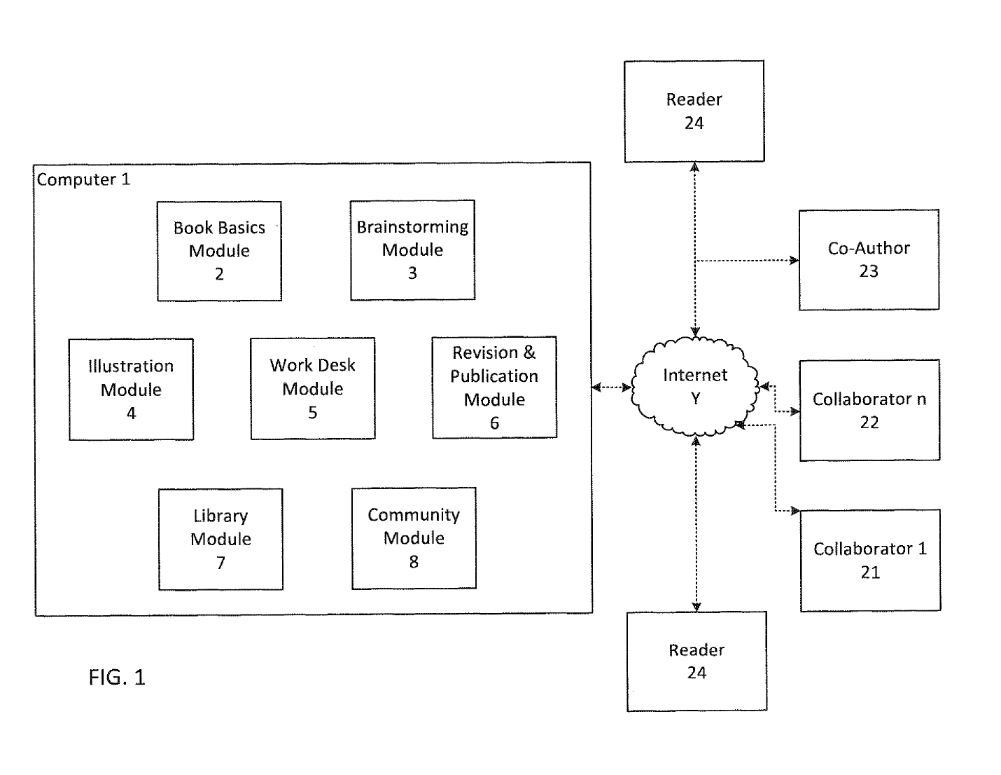

With reference to FIGS. 1 through 7, there is shown a preferred embodiment of a system and method of collaborative and social publication. As shown in FIG. 1, the system includes at least one computer 1, which allows users, such as a primary author 20, a number of collaborators 21, 22, a co-author 23, and a reader to cooperate in the drafting and publication process. Moreover, it should be understood that preferably the system shown in the Figures is primarily a web-based system wherein each user signs on one or more webpages associated with the at least one computer 1. This is accomplished preferably over an open distributed computer system (such as the Internet Y, with each of the users accessing computer 1 using any suitable device, such as a PC, a laptop, a tablet, a smartphone, etc.). It should be understood that while one computer is illustrated in the system, the system may include a plurality of computers to house the required software to perform the functionalities described herein.

The computer 1 incorporates several modules including a book basics module 2, a brainstorming module 3, an illustration module 4, a work desk module 5, a revision and publication module 6, a library module 7, and a community module 8. The computer is preferably implemented as a microprocessor-based device driven by software defining these modules. However, for the sake of clarity, these modules are represented herein as discrete elements.

Also associated with computer is a user database (not shown) which includes data describing a plurality of users who can access the computer via the Internet for various purposes, as discussed below. Preferably, the computer 1 provides subscription-based access to its various functions or modules to a plurality of users that may fall into several different categories, such as primary authors, whose interest is to create original content; collaborators, who are interested in assisting others with the creation of the respective original content; coauthors, who are interested in assisting the primary author with the creating and development of the content; and readers, who are not interested in collaborating or coauthoring but are interested in reading content generated by others.

A coauthor is specifically chosen by a primary author and is afforded substantially the same privileges as a primary author, including the ability to open up a portion of a module to one or many collaborators. It should be understood that, with regards to the modules described below, any of the functions performed by a primary author may be performed by a co-author as well. In a preferred embodiment, once a coauthor is selected and accepts the invitation to coauthor a work, the coauthor will have the same privileges and options as the primary author, and the terms may be interchangeable. In alternative embodiments, the primary author and coauthor(s) may have different privileges.

A collaborator, on the other hand, is selected for assistance during a specific module and is restricted to working on the specific module or portion of a module for which the collaborator has been selected. Furthermore, a collaborator may not invite other collaborators to work on that module. In a preferred embodiment, a collaborator may be granted access to the work desk module 5 for performing the actual writing of a portion of the book, and the revision and publication module 6 for performing proof-reading and editing of the book. In alternative embodiments, a collaborator may be granted access to any of the modules housed within the computer 1.

In one embodiment of the invention, in some sessions, one user may be a primary author, for another session, the same person may be a collaborator, while in a third session, the same user may be only a reader, as will become apparent from the following description.

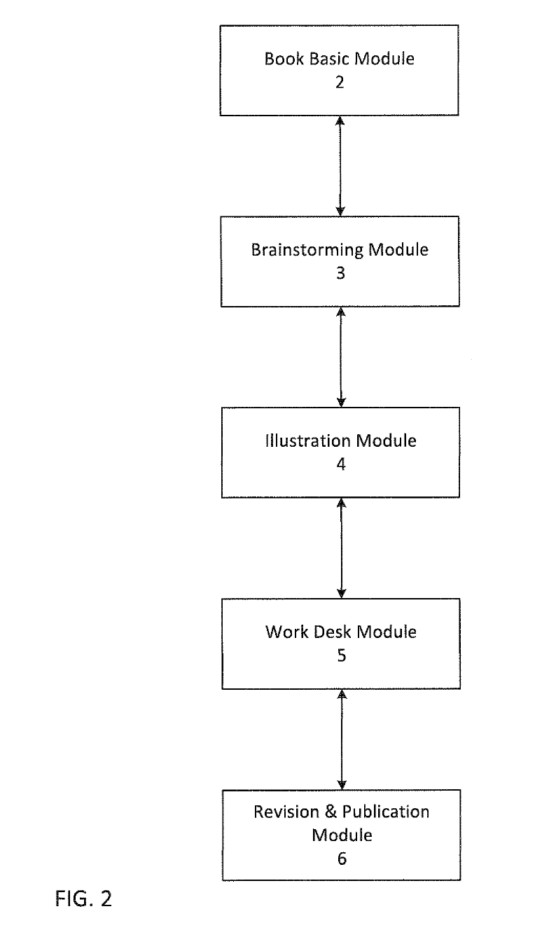

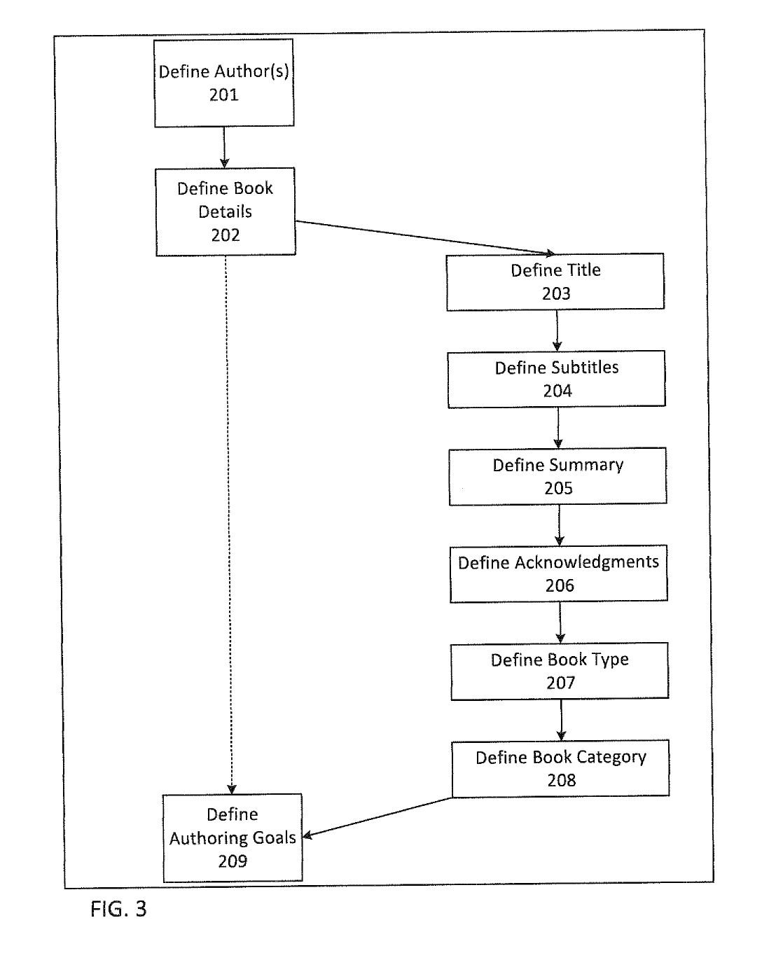

The process of creating and publishing an original book is now described in conjunction with the drawings. With reference to an original book, it should be understood that the term book may refer to any format of book, including, but not limited to, a hard copy format, an audio format, and an electronic format. The process is initiated by a user who signs on to the system and indicates that he wants to generate an original book, i.e. the user is identified as a primary author 20. As a primary author 20, a user can initiate the authoring process and activate modules of the system as illustrated in FIG. 2. Other users can become collaborators 21, 22 or co-authors 23, working with a primary author 20 at any point in any module housed on the computer 1. Furthermore, a user may be a reader 24, and interact with the library module 7 or community module 8 on computer 1. With reference to FIGS. 2 and 3, a primary author 20 is taken through the authoring process by first initiating the book basics module 2. The book basics module 2 identifies the user (or possibly more than one user) as a primary author 20 and one or more users are identifies as coauthors 23 in step 201 (FIG. 3). In one embodiment of the invention, several users can be identified as authors, with one user being designated as a primary author who makes all the administrative decisions as described below. In this embodiment, these designations are provided by the first user who initiates a particular project.

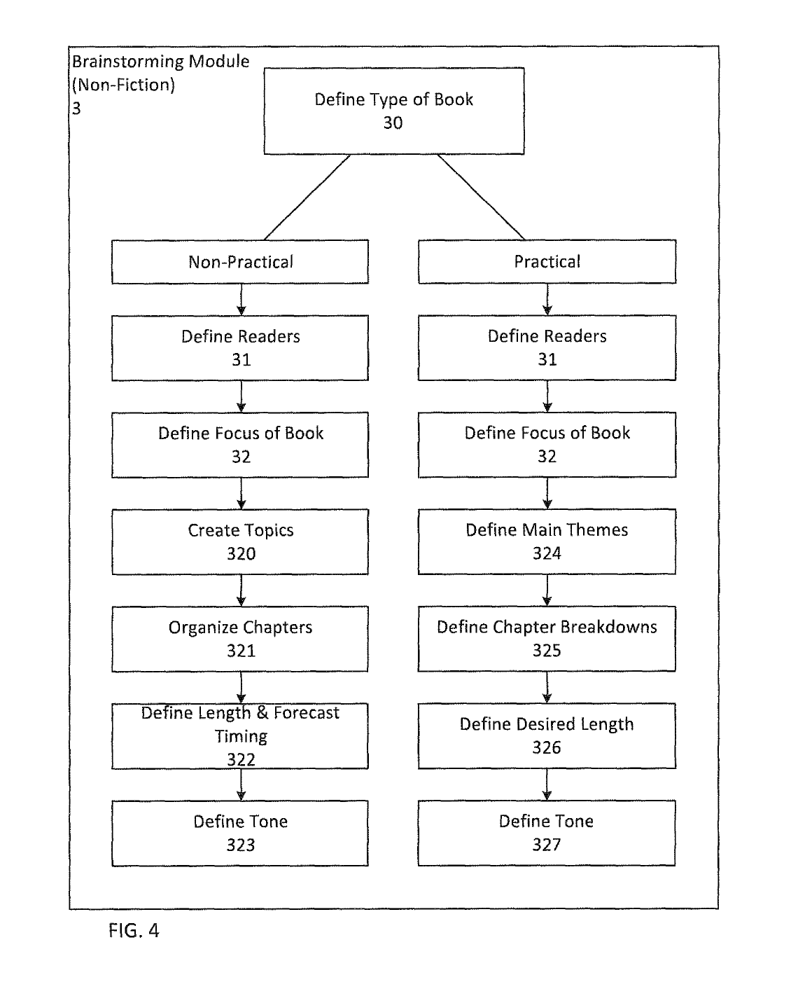

It should be understood that for all the processes described herein, starting with step 201, a screen is presented to the respective user providing the user with a template. Various types of fields are provided on the template that are either selected or filled out by the user. For example, in step 201, the primary author (who is presumably the person initially performing the processes of FIGS. 3 and 4) provides his own name/identification information (unless he has been previously identified). The primary author also enters here the names and/or user identification names of other users who will be authors.

A primary author is able to invite other users to become co-authors as long as the primary author and the co-author are connected as “friends” within the system. Each user has the capability to create a friend list. Users are able to connect as “friends” when a first user requests to be added to a second user's friend list. The second user may then accept or decline the request from the first user. Should the second user accept the request, the first user will be added to the second user's friend list, and the second user will also be added to the first user's friend list.

It shall be understood that co-authors are normally other users who are expected to be listed as such. Collaborators may be users whose contribution may not rise to the level of authorship. Collaborators may be designated either as specific users, or, in an alternate embodiment, a class of users who can be collaborators, such as a group the primary author is connected to or specific users associated with the primary author in a network as “friends”. A group may be set up based on proficiency in a certain topic (e.g., carpentry), geographic area, language proficiency, a rating, as well as other various factors.

For the purposes of the following discussion, a primary author or coauthor performs all of the steps discussed in more detail below in conjunction with the flow chart of FIG. 3. However, in an alternative embodiment of the invention, another user of the system, for example, a collaborator, is granted the right to perform these functions. A primary author or even several authors may need collaborators for several reasons, such as the dreaded writer's block, need to publish the book as expeditiously as possible or by a certain deadline, lack of certain expertise, and so on. The present invention is particularly suited for allowing a continuous, constructive, and intimate cooperation between the author(s) and collaborators by providing a suitable platform that allows the fast, easy, and expeditious creation of an original book.

Returning to the flow chart of FIG. 3, beginning with the book basics module 2, the primary author defines book details (step 202) such as the title (step 203), subtitles (step 204), a summary of the book (step 205), any acknowledgments (step 206), a book type (step 207), and a book category (step 208) within the book type selected in (step 207). Additional features of the book, such as an International Standard Book Number (ISBN), or the like, may also be input in the book basics module 2 at any time during the authoring process. A book type may be selected as fiction or non-fiction. A book category selection is based on the book type selection. If a primary author selects a book type (step 207) as fiction, he is presented with a group of choices as book categories such as drama, fan fiction, fiction, horror-gothic, humor, international, mystery, promotion, psychology, or romance.

If the primary author selects non-fiction as a book type, a book category may be selected (step 208) from a group of options, such as advertising, beauty and fashion, biography, body and spirit, business, career, computer and Internet, eBay, economy, educational, fitness, foods and recipes, garners, general non-fiction, health, history, marketing, parenting and children, philosophy, poetry, politics, quick reads, real estate, recreation and hobby, reference, religious, science, self-improvement, travel, tutorials, websites and Internet, and writing and publishing.

The primary author may also define authoring goals (step 209). Authoring goals (step 209) may include goals such as total word count, daily word count, date to finish, date to publish, weekly word count, monthly word count, or some other user-determined goal. In other words, the book basics module 2 is used to generate a set of initial parameters associated with or providing a framework for the original book.

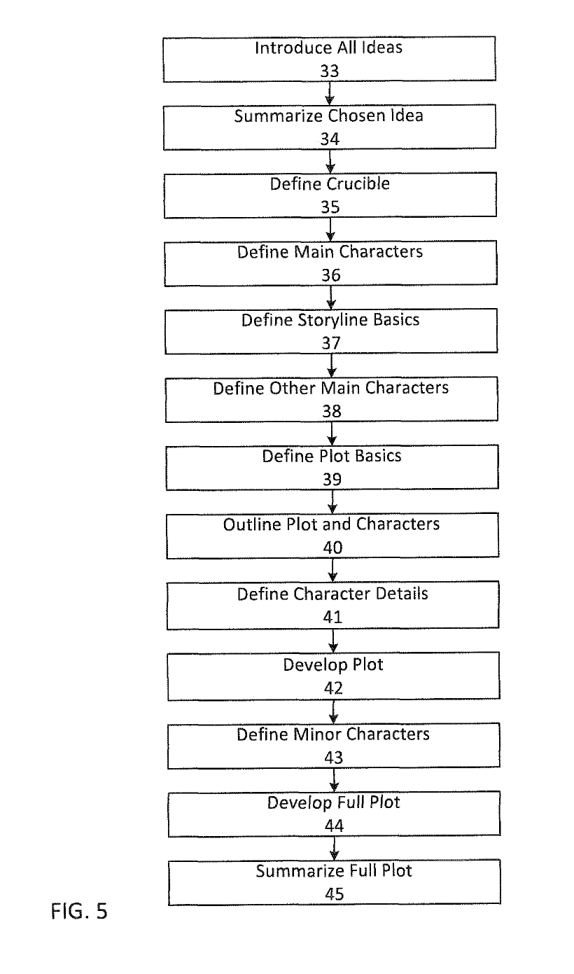

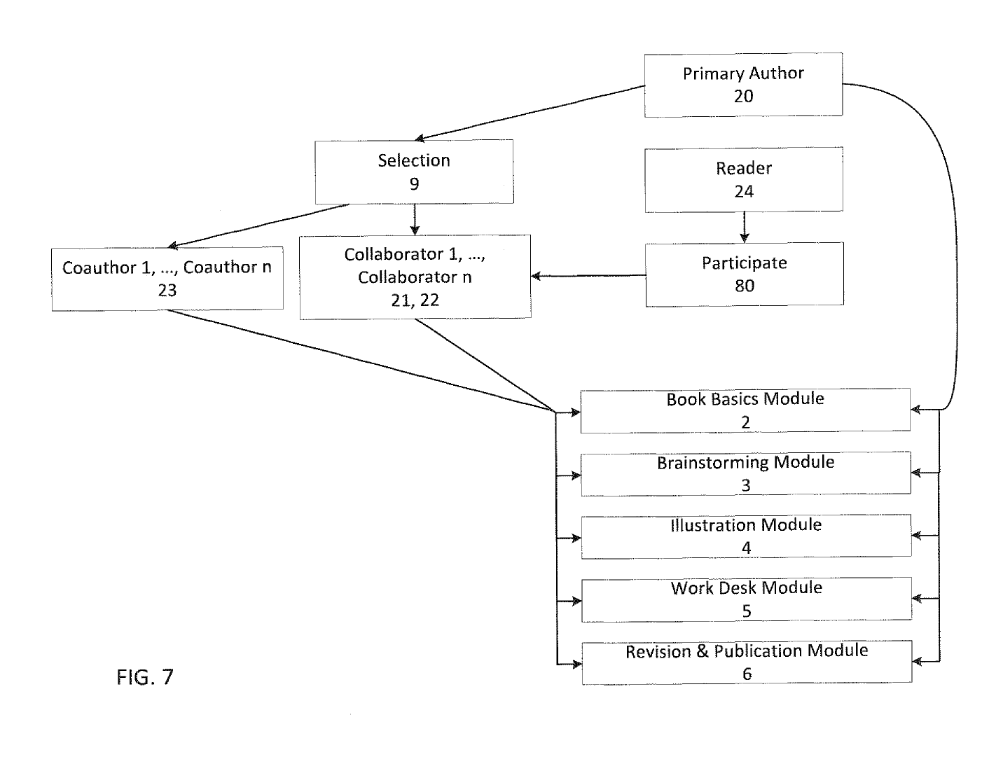

The system further provides online access to the information describing the basic framework for the book as discussed in conjunction with the modules in FIG. 1 and the flow chart in FIG. 3, additional necessary or desirable parameters as shown in the flow charts of FIGS. 4 and 5 and some actual or descriptive content as described in FIGS. 2 and 7 are described below. It should be understood that collaboration can be initiated at any time in the processes described herein, including the book basics module 2 or brainstorming module 3 depicted in FIGS. 3, 4 and 5 but especially for the generation of content as described below and in FIG. 7.

Collaboration may be sought from users associated with a primary author's network (i.e., “friends”), a group, or the entire community. A primary author may request collaboration during any module by activating a “Help” option while engaged in the module that requires assistance. If a primary author requests assistance from a specific friend, that friend will receive a personal notification of the request. By way of example, the friend may receive an electronic notification of the request or the request may be posted to a home page interface of the home page connected to the friend's account. If a group is requested as a collaborator, a request for assistance will be sent to members associated with that group. For example, a request for assistance from a group may be posted to the interface associated with the home page of the group. Lastly, in a preferred embodiment, if a primary author requests collaboration from the entire community, the request will be posted to the interface associated with the participate 80 option of the community module 8. A primary author may seek collaboration from the community using any aspect of the community module 8, including, but not limited to, group page interfaces, a home screen interface, a user-message interface, and any other interface that may be presented to a user of the system.

Moreover, the whole process of creating an original book need not be, and in fact it is not expected to be linear. That is, the primary author can create the parameters discussed in FIG. 3 and then open up the result for the other authors and/collaborators online. The collaborators 21, 22 then can review all the information and content online and, if given permission by a primary author or a coauthor, add more information or content directly. Collaborators 21, 22 may input variables into the respective fields, and/or provide comments to the primary author 20 who can then correct, rewrite, and amend, the materials accordingly.

If a collaborator 21, 22 chooses to provide input to an author 20, the input will be sent as a suggestion to the author 20. If the author 20 chooses to adopt the input sent by a collaborator 21, 22, the author may accept the input and the input will then be merged into the specific module for which the input was intended. When input is accepted and merged, the user who provided the input may be given the option to be acknowledged in the work. For example, the user may be recognized in an acknowledgment section of the book. Such an option includes the choice for a collaborator or coauthor to be listed under a pen name, a username, or an actual name.

In an alternative embodiment, a deadline may be set for a particular module by the author 20 as part of setting up the authoring goals. Once a deadline is reached, collaboration on that particular module will close and the author may review and adopt collaborator suggestions as desired. As collaborator suggestions are adopted, the suggestions will be merged with the module with which the suggestion is associated.

FIG. 4 depicts the brainstorming module 3 for a non-fiction work. The following illustration generally involves more creative activities then what was required for the process of FIG. 3. First, the primary author may define the type of non-fiction book (step 30), the readers (step 31), and the focus of the book (step 32).

In defining the type of book (step 30), a primary author, can choose to write a practical or a non-practical book. The type of readers may be selected (step 31) based on their level of interest or proficiency in the field of the original book (e.g., beginners, interested practitioners, experts); a targeted geographic area (e.g., international, a single country, town or institution); gender of the expected reader (e.g., mainly male, mainly female, or male and female); whether the readers want pure information or information and practical exercises, etc. in defining the focus of the book (step 32), a primary author defines the main idea of the whole book.

If the type of book is defined as a non-practical book, the primary author is prompted to create topics (step 320), organize chapters (step 321), define a length and forecast timing (step 322), and define a tone for the book (step 323). In defining the length of the book, a primary author inputs a desired length variable, such as a desired number of words or pages in each section and inputs a projected speed of writing, such as a number of words per day. The brainstorming module 3 is then able to utilize this information to forecast timing and length data, such as total number of words, average words per section, and how many days until completion.

In defining a tone for the book (step 323), the primary author may define why the audience is reading the book. For example, the primary author may input that the audience is reading for entertainment, information or practical advice. In defining a tone for the book (step 323), the primary author may also input what type of writing will best suit the readers. For example, the primary author may indicate that the audience is best suited for long paragraphs of text or short sections with lots of bullet points. In further defining a tone for the book, the primary author may input a desired amount of illustrations, such as no illustrations or images, a few illustrations or images, or many illustrations or images. In alternative embodiments, the author may provide other options for a desired amount or range of illustrations.

Additionally, when defining the tone for the book (step 323), the primary author may input a desired format of discussion. For example, a primary author may define the format as friendly and chatty, detached and authoritative, or somewhere in between. Finally, in defining a tone for the book (step 323), the primary author may input the type of language to use in writing the book. For example, the primary author may input that the type of language should be everyday language that is easily understood by everyone or complicated language and some subject-related jargon.

If the primary author selects to write a practical work (step 32), the primary author may define main themes (step 324), define chapter breakdowns (step 325), define a desired length and forecast timing (step 326), and define a tone based on that audience (step 329).

In defining a tone for the book (step 327), the primary author may define why the audience is reading the book. For example, the primary author may input that the audience is reading for entertainment, information, or practical advice. In defining a tone for the book (step 327), the primary author may also input what type of writing will best suit the readers. For example, the primary author may input that the audience is best suited for long paragraphs of text or short sections with lots of bullet points. In further defining a tone for the book (step 327), a primary author may input a desired amount of illustrations, such as no illustrations or images, a few illustrations or images, or many illustrations or images. In alternative embodiments, the author may provide other options for a desired amount or range of illustrations. Additionally, when defining the tone for the book (step 327), the primary author may input a desired format of discussion. For example, the format may be friendly and chatty, detached and authoritative, or somewhere in between. Finally, in defining a tone for the book (step 327), the type of language to use in writing the book may be input. For example, language may be chosen from options such as everyday language that is easily understood by everyone or complicated language and some subject-related jargon. If a user desires to author a fictional work, the brainstorming module 3 takes the primary author through a series of prompts based on a fictional work. First the primary author is prompted to find an idea (step 33) by drafting a variety of ideas and selecting ideas the user desires to further explore. Next, the primary author is prompted to input a short sentence or two to describe the summary of the story (step 34). Following the short sentence description (step 34), the primary author is prompted to input the crucible (step 35), including the thing or place that is holding characters in the story together. After inputting the crucible (step 35), the primary author is prompted to describe the main character (step 36) including what it is that the main character must have or do, what compelling reasons may exist for the main character to not have or do that something, and in what way with the main character be different at the end of the story.

Following the inputs on the main character (step 36), the primary author is prompted to input storyline basics (step 37). The storyline basics include information such as the status which includes what the main character is doing when first introduced, how the main character typically exists, and what time and place the main character's story is in; the event that disturbs the status quo, and the main character's response to the disturbance.

Following storyline basics, the primary author is prompted to input information relating to other main characters (step 38) including any friend or partner of the main character, any protective guide, and any antagonist. After information pertaining to other main characters (step 38) is input, the primary author is prompted to input additional plot information (step 39) including information relating to a variety of problems that may arise and how the main character reacts. Next, the primary author is prompted to review an outline of the plot and characters (step 40).

After reviewing the plot and characters (step 40), the primary author is prompted to describe main and other characters in further detail (step 41). This may include information such as physiological traits, sociological traits, psychological traits, and lives traits. Physiological traits may include information such as gender, age, race, height, weight, health, physical scars or abnormalities, posture, voice, or nervousness. Sociological traits may include information such as social class, hometown, the house the character grew up in, the kind of schooling the character attended, the political background of the character's parents, the religious background of the character's parents, the character's parent's attitude towards money, alcohol, sex, ambition, or discipline, and the amount of freedom given to the character as a child. Psychological traits may include information such as fears, loves, ambitions, phobias, complexes, longings, guilt, fantasies, IQ level, special abilities, talents, emotional habits, sense of humor, and things that make the character cry or irritated. Lives traits may include information such as a level of education, occupation, boss, the town or building in which the character resides, a partner, children, siblings, financial situation, languages spoken, verbal tics, the type of clothing the character wears at work or home, and the character's favorite music, book, or film.

Once all major characters are described (step 41), the primary author, may continue to flush out the plot (step 42), adding additional problems that characters face, and how the problems are resolved. Next, the primary author is prompted to input any additional characters the story may require (step 43). This information about additional characters (step 43) may include information such as name, basic physical characteristics, most important psychological characteristics, notable things about first encounters with this character, the character's role in the storyline, what the character wants, and in what ways the character will change.

Finally, the primary author is prompted to develop a plot in full (step 44), upon which a summary (step 45) of all information is then provided. It is imperative to note that because the user may be a primary author 20, co-author 23, or a collaborator 21, 22, any of the steps in the brainstorming process may be completed by any author 20, 23 or collaborator 21, 22, thereby providing a fully-collaborative brainstorming module.

Once a user, either a primary author 20, co-author 23, or a collaborator 21, 22, defines book basics in the book basics module 2 and defines other desired information in the brainstorming module 3, the user may then proceed to the illustration module 4 where the primary author, or otherwise permitted user, can provide illustrations or cover materials for the publication. The primary author, or otherwise permitted user, may also then proceed to the work desk module 5, where he or she may begin the elaborate writing process based on the book basics module 2 and the brainstorming module 3.

As illustrated in FIG. 2, once a work product is completed at the work desk, the primary author, or otherwise permitted user, may proceed to the revision and publication module 6 in order to finalize a work product and begin the publication process. A primary author who completes the publication process in the revision and publication module 6 may then provide their work in the library module 7, where readers may interact with the work and provide feedback. In a preferred embodiment, a user's book is available in the library module 7 once the user chooses to publish. In alternative embodiments, the availability of the book in the library module 7 is determined by the primary author or coauthor.

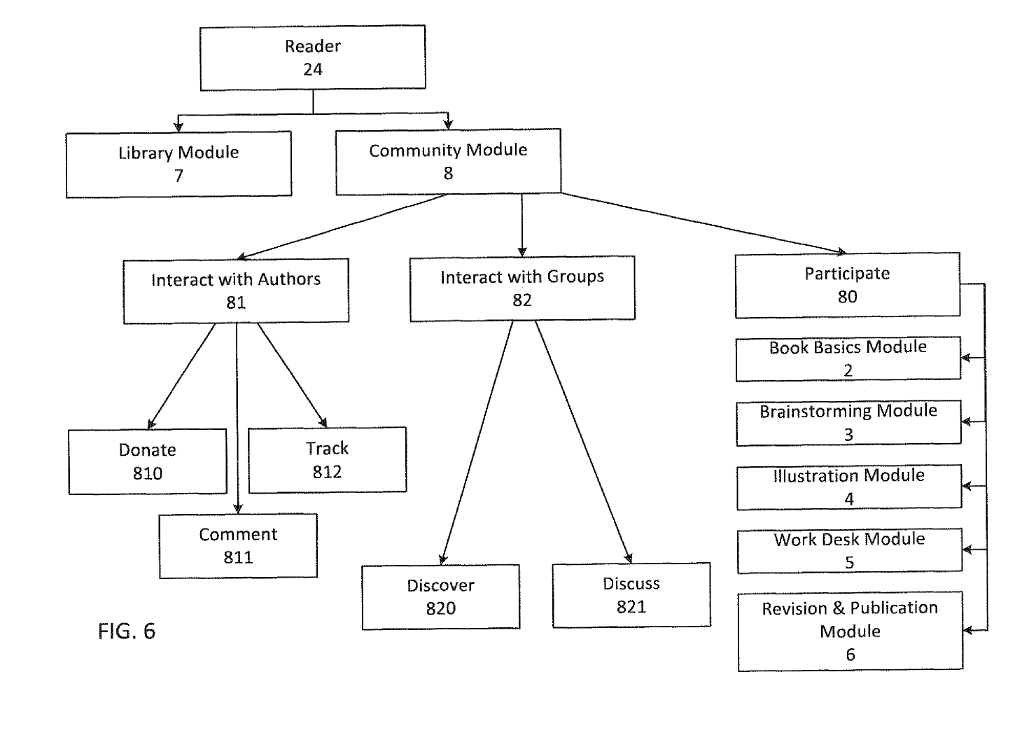

FIG. 7 illustrates the multiple ways the various authoring modules illustrated in FIG. 2 may be utilized by the users. For instance, a primary author 20 may access the book basics module 2, brainstorming module 3, illustration module 4, work desk module 5, or revision and publication module 6 directly for a work in which he or she is the primary author. In another embodiment, a co-author 23 or collaborator 21-22 is determined as a result of a selection 9 made by the primary author 20. The selected co-author or collaborator may then access the book basics module 2, brainstorming module 3, illustration module 4, work desk module 5, or revision and publication module 6 directly for a work in which he or she has been selected to participate. Finally, as depicted in FIG. 6, a reader 24 may become a collaborator 21, 22 through the participation channel 80 of the community module 8.

The community module 8 also allows readers to track authors, join groups based on interests, friends, or other commonalities. Furthermore, the community module 8 is available to provide networking capabilities for all users, including primary authors 20, coauthors 23, collaborators 21, 22, and readers 24.

The library module 7 allows authors to participate in advertising revenue-sharing related to the advertising revenues that are generated alongside their books. In one instance, revenue sharing may be calculated on a popularity-related model whereby revenues are proportioned based on the popularity of a particular work. In another instance, revenue sharing may be calculated based on revenues actually generated for each specific author. Authors may also obtain revenues from the donation section of the community module 8.

Obviously numerous modifications may be made to this invention without departing from its scope as defined in the appended claims.

1. A method for collaborative book publishing over the Internet comprising:
a. initiating a writing basics module;
b. selecting a type of writing from fiction and non-fiction;
c. performing a brainstorming module based on the selected type of writing;
d. drafting a written work in a work desk module based on the brainstorming module;
e. editing and revising the written work in a revision module; and
f. electronically publishing the written work in a publication module;
wherein an at least one author performs the initiation in the writing basics module and selects the type of writing and invites at least one collaborator to perform a portion of the collaborative book publishing selected from the brainstorming module, the work desk module, the revision module, and the publication module.

2. The method for collaborative book publishing of claim 1, wherein the at least one author selects fiction as the type of writing and the brainstorming module further comprises:
introducing ideas for a written work;
summarizing the ideas for the written work;
defining main characters;
defining basics of the storyline;
defining non-main characters;
outlining a plot, main characters, and non-main characters; and
defining details of main and/or non-main characters.

3. The method for collaborative book publishing of claim 1, wherein the at least one author selects non-fiction as the type of writing and the brainstorming module further comprises:
defining who an audience for a written work will be;
defining a focus for the written work;
selecting a category of written work from a practical written work and a non-practical written work;
defining and organizing chapters of the written work based on the type of written work selected category of written work; and
defining a tone associated with the written work.

4. The method for collaborative book publishing of claim 1, wherein the portion of the collaborative book publishing performed by the at least one collaborator is electronically transmitted to the at least one author for review and acceptance and upon acceptance by the at least one author, the portion of the collaborative book publishing performed by the at least one collaborator is saved and merged into the corresponding module.

5. The method for collaborative book publishing of claim 1, further including an illustration module.

6. The method for collaborative book publishing of claim 5, wherein the illustration module may be performed by either the at least one author or the at least one collaborator.

7. The method for collaborative book publishing of claim 1, wherein the invitation of the at least one collaborator is generated by the at least one author and is specific to the at least one collaborator.

8. The method for collaborative book publishing of claim 1, wherein the invitation of the at least one collaborator is generated by the at least one author, is based on a commonality shared by the at least one author and the at least one collaborator, and is not specific to the at least one collaborator.

9. The method for collaborative book publishing of claim 1, wherein the invitation of the at least one collaborator is:
a) generated by a module selected from the grouping of: the writing basics module, the brainstorming module, the work desk module, and the revision module,
b) based on a commonality shared by the at least one author and the at least one collaborator, and
c) is not specific to the at least one collaborator.

10. The method for collaborative book publishing of claim 1, further including a community module that allows an at least one reader to perform a function selected from: tracking the at least one author and joining a grouping of other readers based on a common interest.

11. A system for collaborative book publishing over the Internet comprising:
a computer housing a non-transitory computer-readable medium that stores instructions executable by one or more processors to perform a method for collaborative writing comprising:
a. initiating a writing basics module;
b. selecting a type of writing from fiction and non-fiction;
c. performing a brainstorming module based on the selected type of writing;
d. drafting a written work in a work desk module based on the brainstorming module;
e. editing and revising the written work in a revision module; and
f. electronically publishing the written work in a publication module;
wherein an at least one author performs the initiation in the writing basics module and selects the type of writing and invites at least one collaborator to perform a portion of the collaborative book publishing selected from the brainstorming module, the work desk module, the revision module, and the publication module.
a first database storing an electronic library of published materials; and
a second database storing user information including primary authorship information and collaboration privileges.

12. A non-transitory computer-readable medium that stores instructions executable by one or more processors to perform a method for collaborative writing, comprising:
a. initiating a writing basics module;
b. selecting a type of writing from fiction and non-fiction;
c. performing a brainstorming module based on the selected type of writing;
d. drafting a written work in a work desk module based on the brainstorming module;
e. editing and revising the written work in a revision module; and
f. electronically publishing the written work in a publication module;
wherein an at least one author performs the initiation in the writing basics module and selects the type of writing and invites at least one collaborator to perform a portion of the collaborative book publishing selected from the brainstorming module, the work desk module, the revision module, and the publication module.

13. A non-transitory computer-readable medium that stores instructions executable by one or more processors to perform a method for collaborative writing over the Internet, comprising:
a book basics module, wherein an at least one author initiates the book basics module to begin forming a written work, defines co-authors, and sets authoring goals;
a brainstorming module, wherein the at least one author or an at least one collaborator may provide input regarding organization and content associated with the written work created in the book basics module;
a work desk module, wherein the at least one author or the at least one collaborator may provide input to further develop the written work created in the book basics module and brainstorming module; and
a revision and publication module, wherein the at least one author or the at least one collaborator may provide input to revise and publish the written work.

14. The non-transitory computer-readable medium that stores instructions executable by one or more processors to perform a method for collaborative writing of claim 13, further comprising:
an illustration module, wherein the at least one author or the at least one collaborator may provide input for cover work and illustrations for the written work.

15. The non-transitory computer-readable medium that stores instructions executable by one or more processors to perform a method for collaborative writing of claim 13, further comprising:
a library module, wherein published written works are available for user-reading and review.

16. The non-transitory computer-readable medium that stores instructions executable by one or more processors to perform a method for collaborative writing of claim 13, further comprising:
a community module, wherein a user selects to participate as a collaborator for a written work whereby the at least one author has indicated the desire for a collaborator.
